(19) United States
(12) Patent Application Publication
(10) Pub. No.: US 2012/0096098 A1
(43) Pub. Date: Apr. 19, 2012

(54) SYSTEM AND METHOD FOR AGGREGATING AND DISPLAYING USER PROVIDED CONTENT

(76) Inventor: Edward Balassanian, Kirkland, WA (US)

(21) Appl. No.: 13/274,018

(22) Filed: Oct. 14, 2011

Related U.S. Application Data
(60) Provisional application No. 61/393,264, filed on Oct. 14, 2010.

(51) Int. Cl. G06F 15/16

(52) U.S. Cl. 709/206

(57) ABSTRACT

A system and method for receiving anonymous messages from users. The geographical location and time related to each anonymous message is received and stored by the system. A visual interface displays the anonymous messages based on the geographical location and time for each message. The system allows the determination of the context of the anonymous messages and enables advertisers to place ads among one or more anonymous messages of related context.

### CROSS-REFERENCE TO RELATED APPLICATIONS

This application claims the benefit of Provisional Patent Application Ser. No, 61/393,264, filed Oct. 14, 2010, for all purposes including but not limited to the right of priority and benefit of earlier filing date, and expressly incorporates by reference the entire content of Provisional Patent Application Ser. No. 61/393,264.

### BACKGROUND

Social networking websites allow users to submit messages (known as posts or postings) to share with their friends. Facebook, MySpace and Twitter are common social networking websites among many in the field. In general, users create an account profile page, connect to their friends and post messages on their profile page or friends' page. The profile page shows the messages posted by one or more connected users in a stream (Twitter) or on a wall (Facebook). Additionally, these services allow their users to share photos, video and other personal information with their connected friends.

Specifically, with the social networking service Twitter, a user creates an account, creates a profile containing personally identifiable information and chooses to ‘follow’ another Twitter user or authorizes other Twitter users to ‘follow’ them. When a user chooses to ‘follow’ another user they will receive messages that user posted on Twitter, also known as Tweets. A Twitter user can follow anyone that has granted them permission and can have any number of followers they authorize.

Social networking websites promote the viral sharing of information between users. Users identify one another through name identification, email account identification or other personally identifiable information. Social networking websites often require a user to provide identifiable information during the profile creation process. While requiring personal information about a user eases the ability for friends to find one another on social networking websites, it in turn removes any privacy or anonymity. Twitter and Facebook require that you are identifiable before you are able to tweet or post messages.

In response to the need for anonymity a few websites allow users to post anonymous messages. For example, both secrettweet.com and hadtosay.com allow users to post anonymous messages on their site for anyone to read. These sites provide little visual interface and do not enable users to see postings relative to a specific geographical location, time zone and/or context. Further, the website hadtosay.com still requires the user to create an account to anonymously post. Even further, these websites provide no mechanism for advertisers to post ads along with the anonymous post based on the current context of the anonymous messages.

Prior art provides individuals with the ability to send messages to those within their social network, but these services do not offer anonymity. The services that provide anonymous messaging do little to make the information easy to navigate or easily usable for large numbers of users who reside in multiple locations and time zones. Further, these sites do not employ a mechanism for targeted advertisement by understanding the context of one or more messages, geographical location and time zone of the anonymous messages.

A solution that provides a user interface that is both visually appealing and highly functional for anonymous messaging has eluded those skilled in the art, until now.

A solution that captures relevant information about the anonymous message such as time zone, geographical location or context of the message without requiring personal knowledge of that user has eluded those skilled in the art, until now.

A solution that provides advertisers with a mechanism to target ads among a group of anonymous messages based on one or more factors of time, location and/or context has eluded those skilled in the art, until now.

It would be advantageous to provide a system that enables individuals to submit anonymous messages that are subsequently displayed on a virtual representation of a building or structure or other functional visual interface.

It would also be advantageous to provide a system for users to view anonymous messages that change based on time and/or location.

It would also be advantageous to provide a system for users to search for anonymous messages with regards to a specific context.

It would also be advantageous to provide a system that enables advertisers to place ads among a group of anonymous messages based on one or more factors of time, location and/or message context.

### SUMMARY

In accordance with the present invention, there is provided a system and method for receiving anonymous messages from an individual. Further, the geographical location and time related to the anonymous message is received and stored by the system. Further, there is provided a visual interface displaying all the anonymous messages grouped based on the geographical location and time. The provided system allows the determination of the context of the anonymous messages and enables advertisement companies to place ads among one or more anonymous messages of related context.

### BRIEF DESCRIPTION OF THE DRAWINGS

A complete understanding of the present disclosed system and method may be obtained by reference to the accompanying drawings, when considered in conjunction with the subsequent, detailed description, in which:

FIG. 1 is a flow chart relating to the process of receiving of anonymous messages;

FIG. 2 is a flow chart relating to the process of analyzing anonymous messages;

FIG. 3 is an illustration of an example web page;

FIG. 4 is an illustration of an example message display web page;

FIG. 4B is an illustration of an example message display web page;

FIG. 4C is an illustration of an example message display web page;

FIG. 5 is a flow chart relating to the process of displaying anonymous messages;

FIG. 6 is a flow chart relating to the process of loading and grouping anonymous messages;

FIG. 7 is a flow chart relating the process of submitting advertisements; and

FIG. 8 is an illustration of the system and its components.

For purposes of clarity and brevity, like elements and components will bear the same designations and numbering throughout the Figures.

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware, software, firmware, or some combination thereof in some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like.

Furthermore, the following discussion is for illustrative purposes only, and discusses the present invention reference to various embodiments which may perhaps be best utilized subject to the desires and subjective preferences of various users. One of ordinary skill in the art will, however, appreciate that the present invention may be utilized in a great variety of forms in media environments of any type. Unless explicitly stated, the method embodiments described herein are not constrained to a particular order or sequence. Additionally, some of the described method embodiments or elements thereof can occur or be performed at the same point in time.

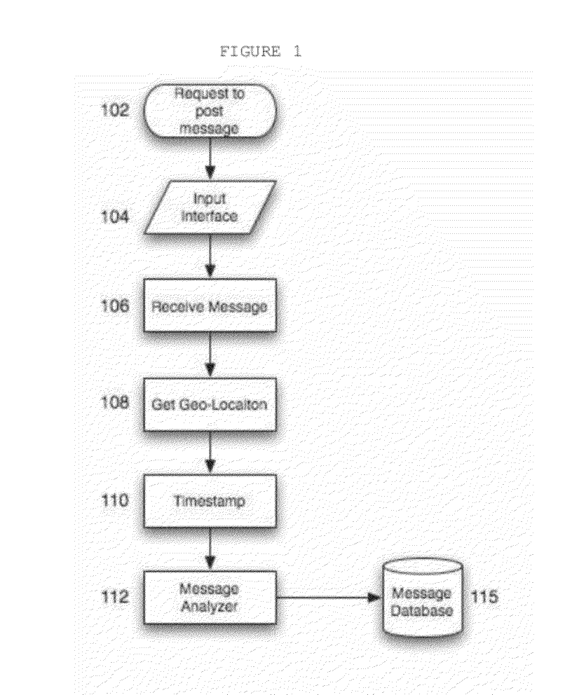

FIG. 1 is a flow chart of the anonymous message receiving process. The process begins when the system receives a request 102 to post a message. The user is not required to provide a name, ID or any other personally identifying information. The system provides an input interface 104 for the user making the message post request. The system is configurable to support input from a variety of input interfaces. Input interfaces are configurable based on the device type of the user. For example, the interface can be a webpage rendered within the browser executing on a personal computer or the interface can be an application executing on a mobile phone. The various interface input techniques in support of multiple types of user devices and implementation trade-offs are well known in the art. Further, the input interface is configurable to restrict the number of characters acceptable. For example the input interface can be configured to limit the number of text characters to 140-characters per message. The user inputs a message into the interface and in the systems receives the message 106. In conjunction with the message the system also receives or determines the geographical location (geo-location) 108 and stores the current time 110 when the message is received. The system is configured to receive or identify the geo-location of the user on both personal computers and mobile devices. To determine the geo-location the system is configurable to use any database or service. For example the system can be configured to use the database or Application Program Interface (API) offered from IPInfoDB to determine a users location by performing a reverse IP lookup. Further, the geo-location data of a mobile device is often accessible through a publically available API provided by the phone manufacturers or mobile operating system providers. Techniques and methods to capture the current time on a computing system are well known through an API accessible by application developers. Next, the message analyzer 112, discussed in greater detail below, analyzes the message. Upon completion of the analysis, the message is stored in the message database 115.

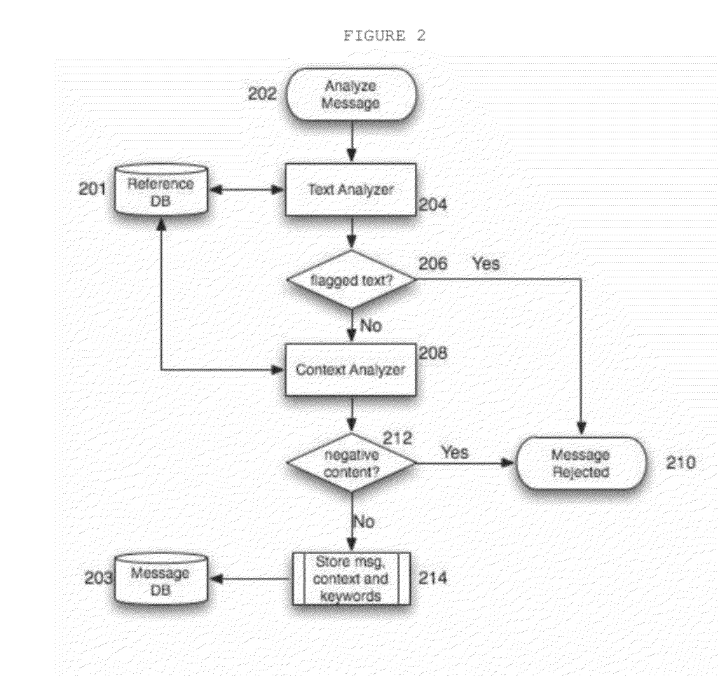

FIG. 2 is a flow chart of the system message analysis process. The process begins with a request from the message receiver to analyze a received message 202. The text analyzer 204 is configured to extract individual words of each message and compare the words to the reference database 201. The text analyzer verifies the message content does not contain curse words or other inflammatory words and terms. Further, the text analyzer is configurable to restrict the types of characters or words acceptable by the anonymous message system. The reference database is used to store characters, words, phrases and message acceptability rules related to the acceptable and non-acceptable content of a message. If it is determined 206 (“Yes”) that the message contains inappropriate text then the message is subsequently rejected 210 and the process ends until the next message analysis request is received. If the message is determined not to contain any flagged text 206 by the text analyzer, the message is then passed to the context analyzer 208 for further analysis. The context analyzer determines the context of a message. Context of a message is used to extract the context or meaning of the message necessary for message filtering and future message placement. The context analyzer is configured to use the reference database 201 to compare the message content against group of words, synonyms, phrases, and keywords. The context analyzer is further configured to reject any message that has been determined to contain a negative context 212. The rules and context used to determine what is negative are stored in the reference database. When no flagged or negative content is determined, the process then stores the message 214 along with the associated keywords and context in the message database 203.

In a further embodiment the system can be configured to selectively perform the text or context analysis steps described above.

In an even further embodiment the message received and analyzed can be in the form of text, audio, image or video. The process of analyzing the message is configurable based on the type of message received. By way of example, if the message is an audio message the process comprises a speech to text engine to convert the audio to text prior to evoking the text analyzer. A further example is a message that contains an image. Employing techniques in pattern recognition and digital geometry, the system can process the image to identify key elements of context. Quantitative and qualitative approaches for identifying key data elements in text, audio, video and images are well known to those skilled in the art.

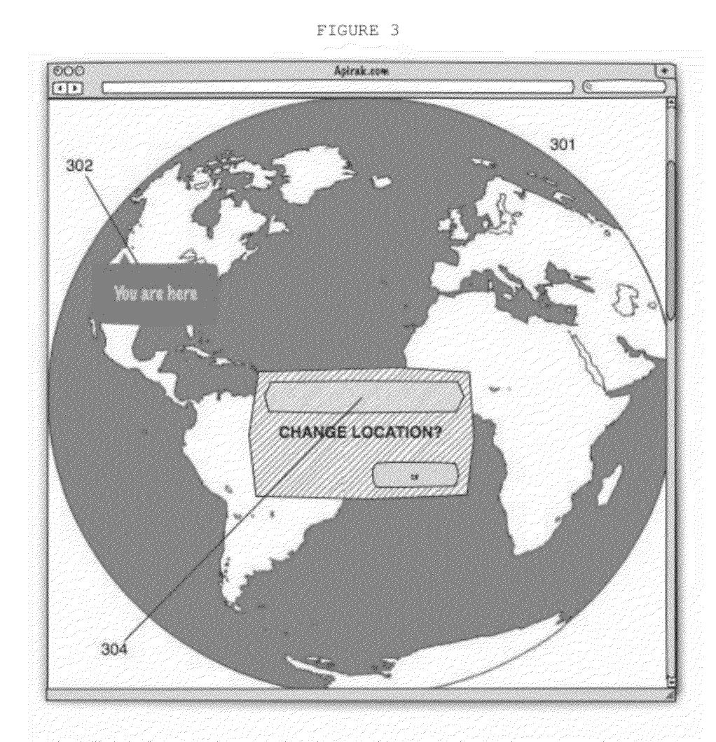

FIG. 3 is an illustration of an example web page for the anonymous posting site home page. In this illustration a globe 301 is presented to the user. Using the location identification techniques discussed above the interface provides an indication of the user's location 302. Additionally the web page can provide an input field 304 to enable the user to change their current location.

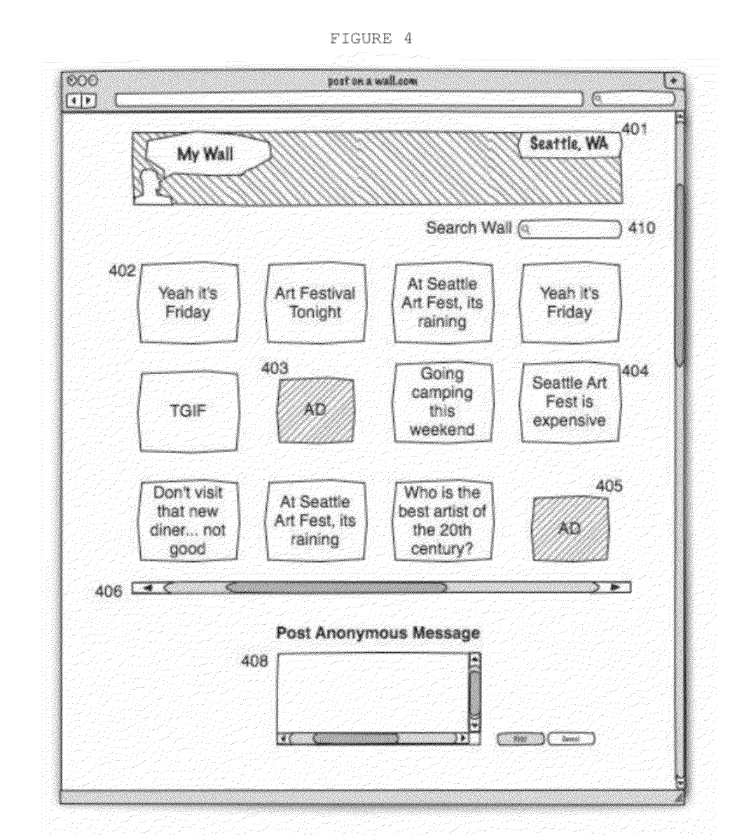

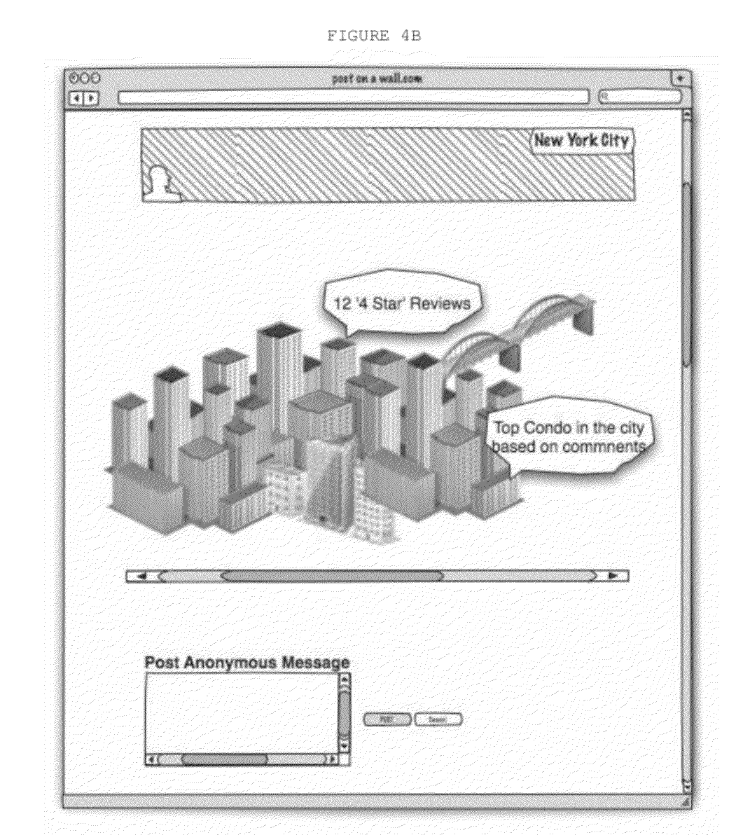

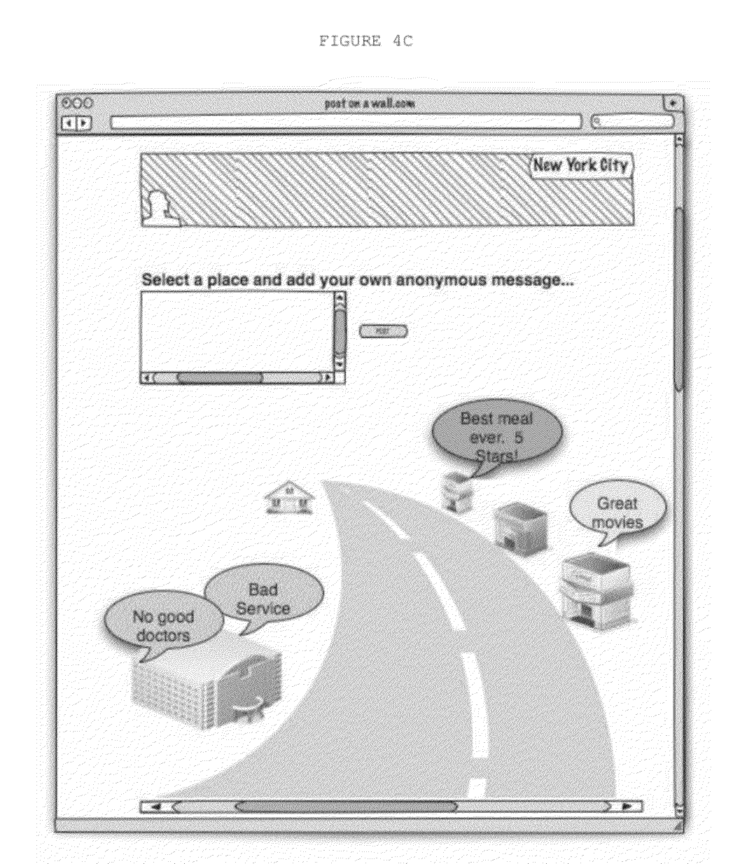

FIG. 4 is an illustration of an example web page of the message display wall. Once a location is known the system presents the previously stored anonymous messages relative to the users location 401. In this illustration the messages are displayed in a grid pattern similar to a wall. The messages can be grouped or displayed based on their submission time or the current time. In this illustration the messages are ordered in a temporal manner with the left side of grid representing older messages 402, while the right side of the grid presents more recent messages 404. A user can change the messages being displayed by adjusting the timeline 406. This number of messages displayed as the timeline is modified is based on the system configuration and grid interface properties. Within this example web page is provided an input interface 408 to post anonymous messages. An input search field 410 is provided for the user to search messages based on keywords or context.

As illustrated, the message wall displays advertisements 403 and 405 among the anonymous messages. In a preferred embodiment the system is configured to display advertisements contextually relevant based on the surrounding messages, time and/or location. Additionally, the system can be configured to display advertisements without contextual relevance. In a preferred embodiment advertisements are denoted among the anonymous messages by modification to the display color, text, background or shape. The selection of advertisements based on the contextual relevance of surrounding messages is discussed in greater detail below.

In a preferred embodiment the visual interface integrates with Google Earth, Bing Maps or other third party mapping and visualization technology such that structural representations are displayed with the associated messages placed in relation to them. The system configures the messages associated with a given location or structure to appear overlaid on top of, along side of or above the user focused location or structure. The process of making the message appear in conjunction with a location or structure is known as pinning. For example, a user posts a message about a specific restaurant and the message appears pinned to the virtual representation of the restaurant building. By using solutions from Google or others, the anonymous messages appear to be pinned on the actual image of the location or structure. The messages pinned to the specific location or structure change based on the user selected timeline. As described above, when the user changes the timeline the messages change accordingly.

FIG. 4B is an illustration of anonymous messages associated with multiple structures from an ‘expanded view’. Displaying all the messages in this format would be too cumbersome for the user and provide little visual usability. In a further embodiment the system is configured to aggregate the context of messages for that area, and selectively extract key information to display to the user. By deriving only key data related to structures or locations that encompass a large number of messages the user can see specific key data. From the expanded interface view a user can zoom-in to a narrower area on the visual map to view specific postings.

FIG. 4C is an illustration of anonymous messages associated with structures from a ‘direct view’. Direct view, displays the structures or specific locations to the user and all the current messages. The user is able to select a specific location or structure and add a message. The messages can change based on the user adjusting the timeline from which to display messages related to that specific location. In a further embodiment a user can place messages on any location, even if the location is different than their current location. The system is configured by default to only allow messages posted to be displayed based on current time and not based on a previous time. Users can only view the messages in the past, not add new ones to past time. For specific locations or times the system contains a customized configuration enabling users to post messages at a given location for a previous point in time.

In an even further embodiment, the user is provided control of the user interface to zoom in and zoom out of a mapped location. The interface changes caused by actions of zooming-in (direct) or zooming-out (expanded) alter the data type displayed, for example individual messages direct view) vs. selected meta-data (expanded view).

It is understood that FIGS. 3, 4A, 4B and 4C are presented as example web pages presented to the user. The system can be configured to present any web page. Further, the web page loaded can be dynamically changed based on the device being used to access the system.

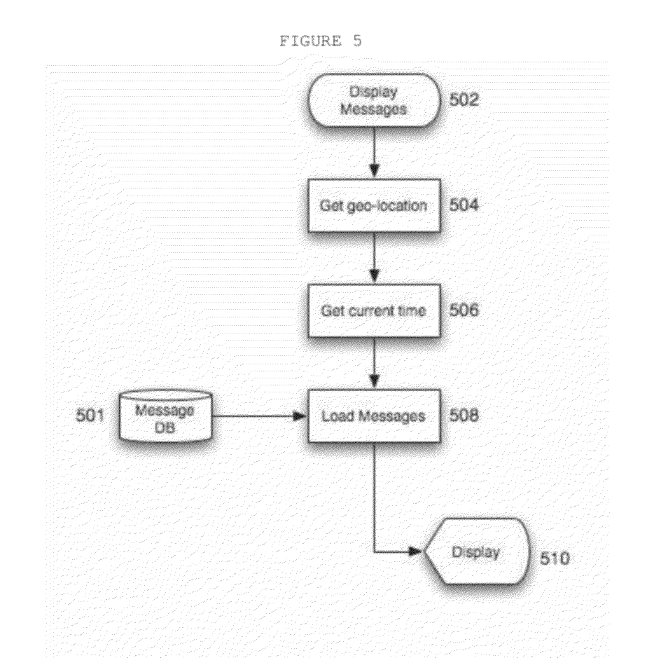

FIG. 5 is a flow chart of the message display process. The process begins by receiving a request 502 to display messages. In a preferred embodiment, the process gets the geographical location and time zone of the user making the request. The related messages to the time and location are loaded 508 from the message database 501. The process for selecting messages based on criteria is discussed detail below. The process ends by displaying 510 the messages based on the configured user interface.

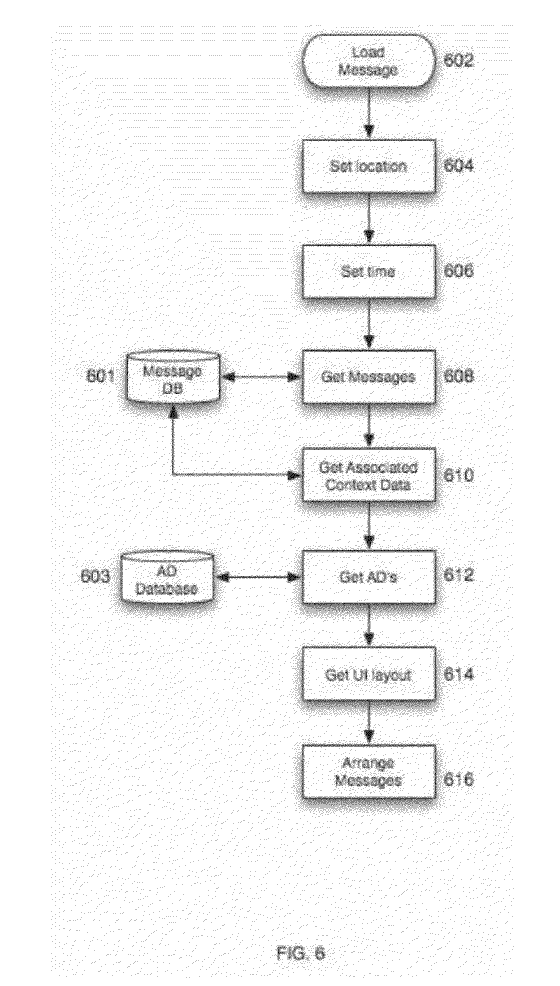

FIG. 6 is a flow chart of the system loading and grouping messages. As discussed above, the system loads messages based on the time and location of the user. The process begins with a request from the display messages process to load messages 602. The messages are retrieved 608 from the database 601 based on the location 604 and time 606 criteria. In addition to the messages the associated contextual data 610 of the messages is retrieved. The related contextual data comprises metadata, keywords or other contextually descriptive information. Next, the process uses the contextual information to retrieve advertisements 612 from the ad database 603. The contextual data of the messages is compared to the contextual data of the stored advertisements. Only the advertisements that contain related contextual data to that of the messages are loaded. Next, the system requests the user interface layout 614. The display of messages is configurable based on the user interface layout requirements of the device being used to access the system. Once the user interface layout is known the process ends by arranging the messages and advertisements for display 616 to the user.

In a preferred embodiment advertisements are displayed close proximity to the messages that have similar context or keywords. The placement of the advertisements based on proximity is further based on time and location. Even further, the number of advertisements is dynamic based on the user interface layout requirements. For example, the layout can restrict the number of advertisements to display to 1 in 30. This means that of 30 anonymous messages shown to a user, one will be an advertisement. The advertisement displayed is based on the context of the surrounding messages. Exactly which message of 30 will be an advertisement can be set by the system to a specific or random placement.

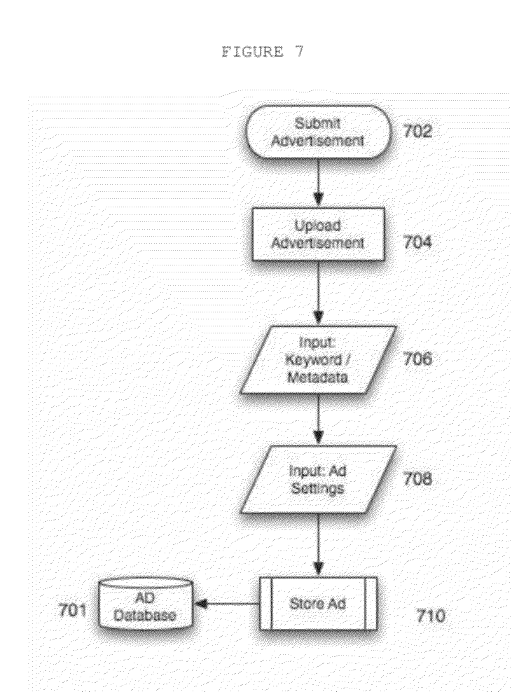

FIG. 7 is a flow chart of the advertisement submission process. The process begins when an advertiser makes a request 702 to submit an advertisement. The system provides a web portal for advertisers to upload advertisements 704. In a preferred embodiment advertisements are images. The advertiser provides keywords, metadata or other contextual data related to the advertisement 706. Next the advertiser enters information regarding the display of the advertisement 708. This information relates to time zones, locations and maximum budget. The system is configurable to support common internet advertising models; Cost per impression (CPM), Cost per Click (CPC) and Cost per Action (CPA). Once the advertisement is uploaded and associated data is entered the process stores the advertisement and data 710 in the advertisement database 701.

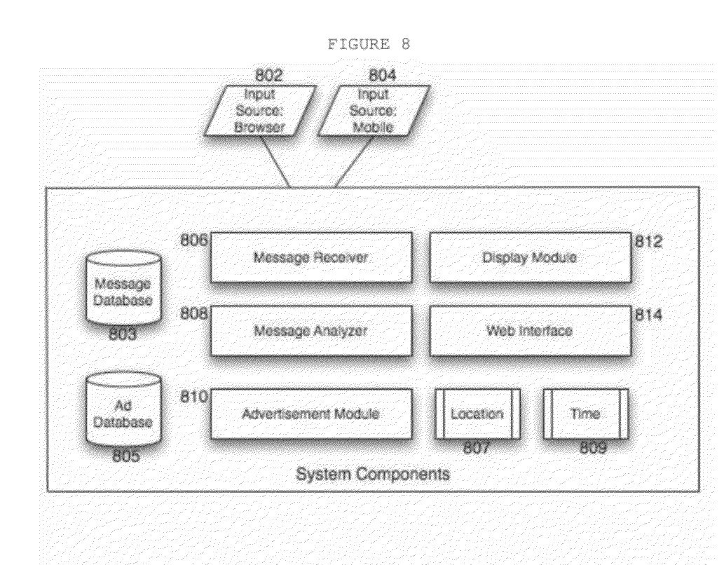

FIG. 8 is an illustration of the components that comprise the system described in detail above. The system comprises a message receiver module 806 configured to receive input from multiple types of input sources. For example, the source can be a browser executing on a personal computer 802 or a mobile device 804. The system comprises databases to store message data 803 and advertisement data 805. A message analyzer 808 analyzes the messages received prior to storage and display. The advertisement module 810 provides a portal and management tools for advertisers. A location module 807 is employed to look-up the geographical location of the individual submitting a message when the information is not provided in conjunction with the message submission. A time module 809 is employed to capture the time a message is submitted to the system. A display module 812 is used to arrange the messages, The web interface module 814 is responsible for the web pages relating to the system and its services.

Thus, in summary, it can be seen that what is described in this disclosure is a system that accepts anonymous messages, analyzes the messages, extracts contextual information, accepts advertisements with associated metadata and provides a method for displaying the messages and advertisements in a manner based on location, time and context.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A system for displaying one or more messages from one or more users, comprising:
a message receiver configured to receive the one or more messages from the one or more users;
a message analyzer configured to analyze the one or more messages;
a location module configured to determine the location of each user in the one or more users;
a time module configured to determine the time each message in the one or more messages is received by the message receiver;
a message database configured to store the one or more messages, the message database being further configured to store location and time information in conjunction with the one or more messages;
a web interface configured to display the one or more messages, wherein each particular message in the one or more messages is displayed based on the location of the user who sent the particular message.

2. The system of claim 1 wherein at least one message in the one or more messages is anonymous.

3. The system of claim 1 wherein at least one message in the one or more messages is associated with a specific individual.

4. The system of claim 1 wherein at least one message in the one or more messages comprises at least one of: text, image, audio, or video.

5. The system of claim 1 wherein the message analyzer is further configured to determine keywords for the purposes of advertisement;

6. The system of claim 1 wherein the message analyzer is further configured to determine offensive language within a message.

7. The system of claim 1 wherein the system further comprises an advertisement database.

8. The system of claim 7 wherein the advertisement database is configured to determine the context of at least one message at a specific location and is further configured to display contextually similar advertisements in association with the at least one message at a specific location.

9. The system of claim 1 wherein only messages within a specific location are displayed.

10. The system of claim 9 wherein only messages within a specific time period are displayed.

11. The system of claim 1 wherein at least one message in the one or more messages is displayed on a visual map relative to the geographical location from which the at least one message was submitted.

12. The system of claim 1 wherein at least one message in the one or more messages is displayed on a visual representation of a building or structure relative to the geographical location from which the at least one message was submitted.
